(19) United States
(12) Patent Application Publication
(10) Pub. No.: US 2011/0199272 A1
(43) Pub. Date: Aug. 18, 2011

(54) FIELD-CONFINED PRINTED CIRCUIT BOARD-PRINTED ANTENNA FOR RADIO FREQUENCY FRONT END INTEGRATED CIRCUITS

(76) Inventors: ZIMING HE, Irvine, CA (US); Ping Peng, Irvine, CA (US)

(21) Appl. No.: 13/029,554

(22) Filed: Feb. 17, 2011

Related U.S. Application Data
(60) Provisional application No. 61/305,288, filed on Feb. 17, 2010.

(51) Int. Cl. H01Q 7/00; H01Q 11/12

(52) U.S. Cl. 343/741

(57) ABSTRACT

A printed circuit board (PCB)-printed antenna is disclosed. There is a printed circuit board substrate, and an electrically conductive radiating element fixed thereto. The radiating element is defined by a first main branch segment, a second main branch segment in a spaced parallel relation thereto, and a perpendicular bend segment connecting the first and second main branch segments. A feed line is electrically connected to the radiating element, and defines a feed port. Additionally, a ground line is electrically connected to the radiating element, and defines a ground port. A high frequency current loop is successively formed with an origin from the feed line, to the first main branch segment, to the bend segment, to the second main branch segment, and with a terminus of the ground line. The high frequency current loop confines the current and electromagnetic fields on the radiating element.

### CROSS-REFERENCE TO RELATED APPLICATIONS

This application relates to and claims the benefit of U.S. Provisional Application No. 61/305,288 filed Feb. 17, 2010 and entitled “A FIELD-CONFINED PRINTED ANTENNA FOR RF FRONT-END IC APPLICATIONS”, which is wholly incorporated by reference herein.

### STATEMENT RE: FEDERALLY SPONSORED RESEARCH/DEVELOPMENT

Not Applicable

### BACKGROUND

1. Technical Field

The present disclosure relates generally to radio frequency (RF) communications and antennas, and more particularly to a field-confined printed circuit board-printed antenna for use with RF front end integrated circuits.

2. Related Art

Wireless communications systems find application in numerous contexts involving information transfer over long and short distances alike, and there exists a wide range of modalities suited to meet the particular needs of each. These systems include cellular telephones and two-way radios for distant voice communications, as well as shorter-range data networks for computer systems, among many others. Generally, wireless communications involve a radio frequency (RF) carrier signal that is variously modulated to represent data, and the modulation, transmission, receipt, and demodulation of the signal conform to a set of standards for coordination of the same.

One fundamental component of any wireless communications system is the transceiver, i.e., the transmitter circuitry and the receiver circuitry. The transceiver encodes information (whether it be digital or analog) to a baseband signal and modules the baseband signal with an RF carrier signal. Upon receipt, the transceiver down-converts the RF signal, demodulates the baseband signal, and decodes the information represented by the baseband signal. The transceiver itself typically does not generate sufficient power or have sufficient sensitivity for reliable communications. The wireless communication system therefore includes a front end module (FEM) with a power amplifier for boosting the transmitted signal, and a low noise amplifier for increasing reception sensitivity.

Another fundamental component of a wireless communications system is the antenna, which is a device that allow for the transfer of the generated RF signal from the transceiver/front end module to electromagnetic waves that propagate through space. The receiving antenna, in turn, performs the reciprocal process of turning the electromagnetic waves into an electrical signal or voltage at its terminals that is to be processed by the transceiver/front end module. A variety of antenna structures are known in the art, including balanced fed dipoles, monopoles, loops, and so forth. Typically, antennas are physically large, though the miniaturization demands of recent mobile communication devices have led to size decreases. Along with miniaturization, however, an ever-increasing amount of functionality is being incorporated, requiring improved antenna performance.

Although the Industrial, Scientific, and Medical (ISM) frequency band was not originally intended for communications purposes, there are, indeed, many successful implementations of various wireless communication systems utilizing it. For instance, the Institute of Electrical and Electronics Engineers (IEEE) 802.11x series of wireless networking standards, also known as WiFi, use the 2.4 GHz, 3.6 GHz, and the 5 GHz ISM frequency bands. Furthermore, personal area network systems such as Bluetooth and Zigbee utilize the 2.4 GHz and 915 MHz ISM frequency bands. The devices that utilize these communications subsystems are typically diminutive in size, and so the antennas may be implemented as specifically configured traces on a printed circuit board. Other components of the device circuitry may be mounted to the printed circuit board, thus further reducing size and cost.

In general, antenna design involves a compromise between wide bandwidth and physical size. Current high-speed data transfer rates may require a bandwidth of 100 MHz or more depending upon specific applications and operating frequency bands. Further, with antennas utilized in mobile and other portable communication devices, several other factors must be considered as well. High gain and efficiency requirements must be met because of the limited power source inherent in those devices while also meeting the minimum communication link requirements for the entire system.

There must also be an adequately low return loss, so that satisfactory performance of the transceiver and the front end module are maintained even when the operating point has drifted beyond a normal range. As the various electrical components of mobile and portable communications devices are densely packed, interference between the antenna and such nearby components is also a source of performance degradation. With current antenna designs, the return loss (S11) at the edges of the operating frequency band is typically around −5 dB, leading to a reduced performance of the front end module. This, in turn, reduces the total radiated power and the total integrated sensitivity of the transceiver by increasing the noise figure, leading to digital signal quality degradation, shorter communication link distances, slower data throughput, and rapid depletion of battery energy. However, if the return loss (S11) is reduced to −15 dB, such performance degradation are understood to be minimal.

Aside from the foregoing performance considerations, modern communications devices must be manufactured and sold at a sufficiently low price point for market acceptance. Therefore, the reduction of costs associated with the materials and construction of antennas, as well as the other components, is an important design objective.

Accordingly, there is a need in the art for an improved field-confined printed circuit board-printed antenna with excellent return loss and high radiation efficiency characteristics across a typical operating bandwidth.

### BRIEF SUMMARY

In accordance with various embodiments of the present disclosure, there is contemplated a printed circuit board (PCB)-printed antenna for a radio frequency (RF) front end integrated circuit with an antenna port. The printed antenna may include a printed circuit board substrate. Additionally, there may be an electrically conductive radiating element that is fixed to the printed circuit board substrate. The radiating element may be defined by a first main branch segment, a second main branch segment in a spaced parallel relation thereto, and a perpendicular bend segment connecting the first and second main branch segments. There may also be a feed line that is electrically connected to the radiating element. The feed line may define a feed port connectible to the antenna port of the RF front end integrated circuit. The printed antenna may further include a ground line that is electrically connected to the radiating element. A high frequency current loop may be successively formed with an origin from the feed line, to the first main branch segment, to the bend segment, to the second main branch segment, and with a terminus of the ground line. The high frequency current loop may confine current and electromagnetic fields on the radiating element. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of one embodiment of a printed circuit board-printed antenna mounted on a radio frequency (RF) communications device;

FIG. 2A is a top plan view of the printed circuit board upon which the antenna is printed;

FIG. 2B is a bottom plan view of the printed circuit board shown in FIG. 2A;

FIG. 3 is a top plan view of a the printed antenna showing a radiating element, a feed line, and a ground line in accordance with various embodiments of the present disclosure;

FIG. 4 is a chart illustrating the simulated return loss of the presently disclosed printed antenna;

FIG. 5 is a Smith chart showing the return loss of the presently disclosed printed antenna;

FIG. 6 is a graph illustrating a simulated radiation pattern of the printed antenna; and

FIG. 7 is a graph illustrating a simulated current distribution pattern of the printed antenna and the surface of the printed circuit board.

Common reference numerals are used throughout the drawings and the detailed description to indicate the same elements.

### DETAILED DESCRIPTION

A printed circuit board (PCB)-printed antenna having field-confined, wideband and high efficiency performance features is contemplated in accordance with various embodiments of the present disclosure. In one operating frequency band of 2400 MHz to 2483.5 MHz, the return loss is contemplated to be better than −22 dB. Furthermore, its bandwidth where the return loss (S11) is −10 dB is envisioned to be around 360 MHz. Additionally, the printed antenna has stable performance and not prone to degradation or detuning resulting from nearby components and from objects placed in its vicinity. The detailed description set forth below in connection with the appended drawings is intended as a description of the several presently contemplated embodiments of the antenna assembly, and is not intended to represent the only form in which the disclosed invention may be developed or utilized. The description sets forth the functions and structural features in connection with the illustrated embodiments. It is to be understood, however, that the same or equivalent functions may be accomplished by different embodiments that are also intended to be encompassed within the scope of the present disclosure. It is further understood that the use of relational terms such as first and second, top and bottom, and the like are used solely to distinguish one from another entity without necessarily requiring or implying any actual such relationship or order between such entities. The present application relates to co-pending U.S. application Ser. No. 12/914,922 entitled “FIELD-CONFINED WIDEBAND ANTENNA FOR RADIO FREQUENCY FRONT END INTEGRATED CIRCUITS, the disclosure of which is also expressly incorporated by reference in its entirety herein.

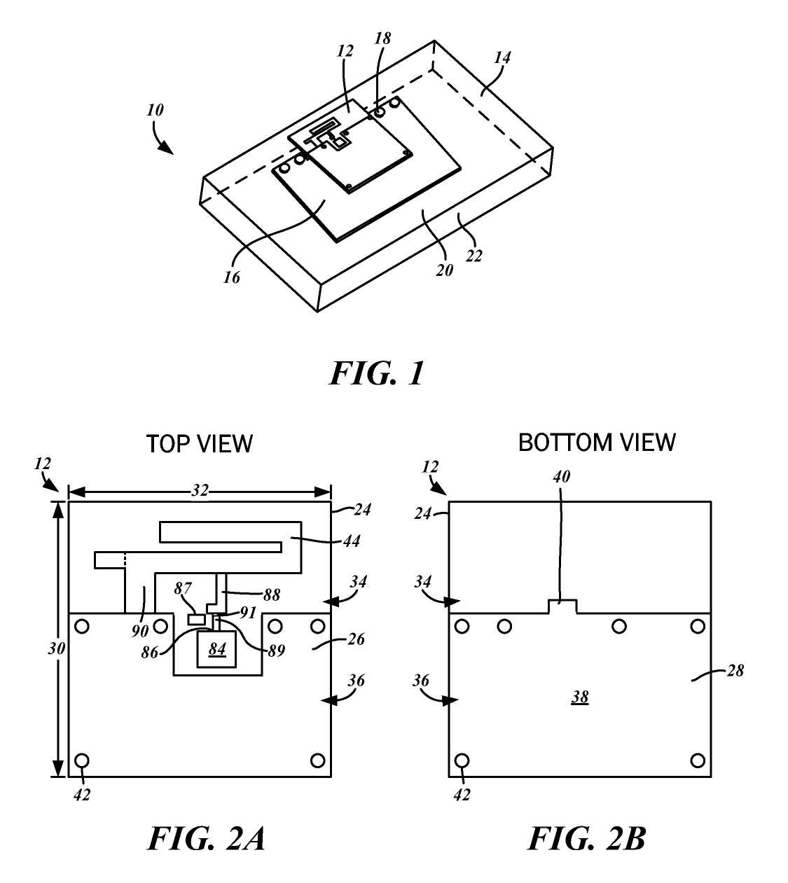

With reference to FIG. 1, an exemplary radio frequency (RF) communications device 10 includes a PCB-printed antenna assembly 12. By way of example only and not of limitation, the RF communications device 10 may have a variety of configurations and components in accordance therewith. For purposes of simplification and not showing any more features than is necessary to fully disclose the pertinent features of the contemplated PCB-printed antenna assembly 12, most such additional details of the RF communications device 10 will be omitted. However, some commonly utilized components that may otherwise have a detrimental effect have been included to illustrate the performance of the PCB-printed antenna assembly 12 under typical operating conditions. In this regard, the RF communications device 10 may be comprised of a plastic casing 14, within which the PCB-printed antenna assembly 12 is disposed. Additionally, the RF communications device 10 may include a liquid crystal display (LCD) panel assembly 16 that is mounted to the casing 14 via a set of screws 18. The casing 14 has a quadrilateral configuration with a flat planar top surface 20 and an opposed bottom flat planar surface 22. The PCB-printed antenna assembly 12 is disposed along the flat planar top surface 20 to expose its radiating element, the details of which will be considered more fully below. The LCD panel assembly 16 is disposed underneath the PCB-printed antenna assembly 12, within the casing 14.

In general, the RF communications device 10 and the PCB-printed antenna assembly 12 are understood to implement WiFi, Bluetooth, and/or ZigBee data communications over the 2.4 GHz ISM band. It will be appreciated by those having ordinary skill in the art, however, that certain noted operational parameters may be adapted for other communications modalities with different operating frequency bands and bandwidth parameters to meet the requirements thereof.

As further detailed in FIGS. 2A and 2B, the PCB-printed antenna assembly 12 is generally defined by a PCB substrate 24 with a planar, quadrilateral configuration with a top surface 26 and an opposed bottom surface 28. Additionally, the PCB substrate 24 is characterized by a length 30 and a width 32. By way of example only and not of limitation, the PCB substrate 24 may be conventional glass-reinforced epoxy substrate of 60 mil thickness (1.524 mm) laminated with 1 oz. copper foil, also designated as FR4. The PCB substrate 24 may have dimensions of 40 mm×38 mm. These dimensions may be modified to conform to the structural constraints of the RF communications device 10. Other types of PCB substrates and copper foil thicknesses may be substituted, with corresponding modifications being made to the various aspects of the PCB-printed antenna assembly 12 to meet the stated performance objectives.

The PCB substrate 24 may also be divided into a first section 34 and a second section 36. On the bottom surface 28 of the PCB substrate 24 best illustrated in FIG. 2B, the second section 36 includes a ground plane 38 comprised of the aforementioned copper laminate. On the first section 34, on the bottom surface 28, no copper laminate remains except for an extended section 40, the details of which will be discussed more fully below. As will be recognized by those having ordinary skill in the art, the ground plane 38 reduces noise, and references the various components of the RF communications device 10 to the same common. From the top surface 26 to the bottom surface 28 extend several vias 42, electrically connecting the ground or common junctions of the circuit components mounted to the top surface 26 to the ground plane 38.

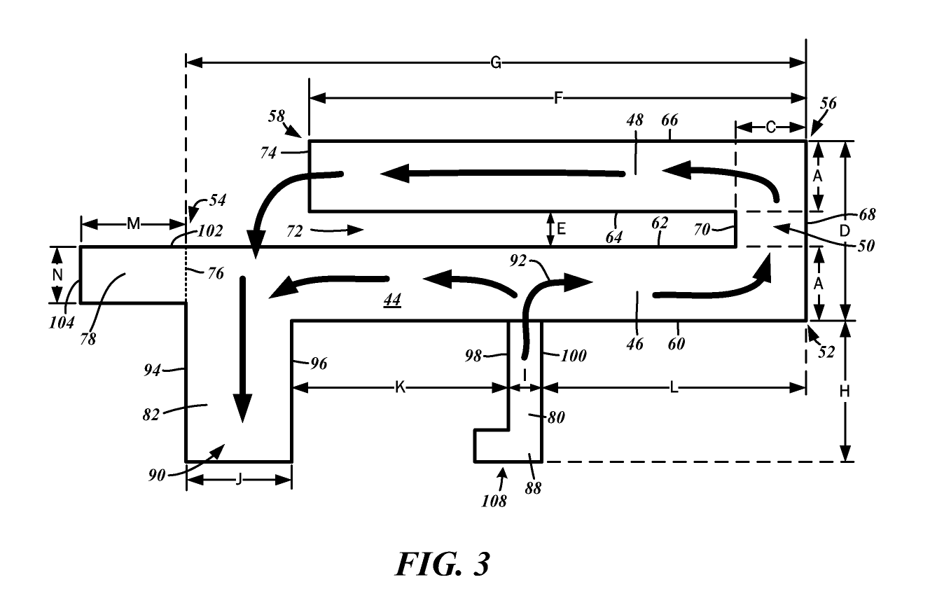

An electrically conductive radiating element 44 is fixed to the top surface 26 on the first section 34 of the PCB substrate 24, and the details pertaining to the structural features thereof being shown in FIG. 3. For wireless communication applications in general, the design of an embedded antenna involves several considerations as discussed briefly above. These include small size, high performance (bandwidth, gain/efficiency, return loss, noise figure, resistance to external influences, specific absorption rate (SAR), etc.) and low cost. The features of the radiating element 44 have been contemplated in accordance with such considerations.

The radiating element 44 is defined by a first main branch segment 46, as well as a second main branch segment 48 that is in a spaced parallel relation thereto. The first main branch segment 46 and the second main branch segment 48 are interconnected with a perpendicular bend segment 50. The various segments of the radiating element 44 are approximate designations only, in that there may be overlaps therebetween. For example, parts of the first main branch segment 46 may overlap with parts of the bend segment 50. Accordingly, the specific nomenclature referenced for different parts of the radiating element 44 is not intended to be limiting. The first main branch segment 46 has a first end 52 that is proximal to the bend segment 50, and an opposed second end 54. Similarly, the second main branch segment 48 has a first end 56 proximal to the bend segment 50, and an opposed second end 58.

The radiating element 44 has a predetermined width that is unvarying from the first main branch segment 46, the bend segment 50, and the second main branch segment 48. In one contemplated embodiment, the width is 2 mm. Thus, a dimension A between a lower lengthwise edge 60 and an upper lengthwise edge 62 of the first main branch segment 46 is 2 mm. Likewise, a dimension B between a lower lengthwise edge 64 and an upper lengthwise edge 66 of the second main branch segment 48 is also understood to be 2 mm. The bend segment 50 defines a right edge 68 that generally corresponds to the first end 52 of the first main branch segment 46, and the first end 56 of the second main branch segment 48. Opposite the right edge 68 of the bend segment 50 is a left edge 70, and a dimension C between the two also being 2 mm.

Additional details regarding the lengthwise dimensions of the radiating element 44 will now be considered. A dimension D of the right edge 68, between the lower lengthwise edge 60 of the first main branch segment 46 and the upper lengthwise edge 66 of the second main branch segment 48, is understood to be 5 mm. In this regard, a gap 72 defined between the first main branch segment 46 and the second main branch segment 48 is understood to have a dimension E of 1 mm. From the right edge 68 to an opposite left edge 74 that substantially corresponds to the second end 58, along the upper lengthwise edge 66 of the second main branch segment 48, there is a dimension F of 13.9 mm. Essentially, dimension F is understood to be the length of the second main branch segment 48.

From the right edge 68 to an opposite left edge 76 that corresponds to the second end 54, there is defined a dimension G, which is 17.3 mm in accordance with some embodiments. It is understood that while the radiating element 44 appears to extend beyond the aforementioned left edge 76, this portion is understood to be a tuning block 78 that is distinct therefrom. Thus, the left edge 76 is not a physical edge of the conductive material as is the case with the right edge 68, but rather, an conceptual edge of the first main branch segment 46. Similar to the dimension F for the second main branch segment 48, the dimension G is understood to define the length of the first main branch segment 46.

Extending from the radiating element 44 in an inverse-“F” configuration are a feed line 80 and a ground line 82. In further detail, the feed line 80 is electrically connected to the first main branch segment 46, and in some embodiments, it is integrally formed and structurally contiguous therewith. Likewise, the ground line 82 is electrically connected to the first main branch segment 46, and may be integrally formed and structurally or mechanically contiguous with the radiating element 44. Both the feed line 80 and the ground line 82 have a lengthwise dimension H of 4 mm.

However, other dimensions of the feed line 80 and the ground line 82 may differ. For example, the feed line 80 may have a width dimension I of 0.9 mm, while the ground line 82 may have a width dimension J of 3 mm. As shown in the illustrated example, the width of the ground line 82 is selected to be about three times that of the feed line 80 for maximum bandwidth. Furthermore, the width of the radiating element 44 as shown above, is selected to be about twice that of the feed line 80.

Referring back to FIG. 2A, the radiating element 44 is electrically connected a RF front end integrated circuit 84 that has an antenna port 86, as well as the ground plane 38. Accordingly, the feed line 80 defines a feed port 88 and the ground line 82 defines a ground port 90 that serves as an interface to the antenna port 86 and the ground plane 38, respectively. The antenna port 86 is connected to the feed port 88 via a microstrip line 89, which may have an impedance of 50 Ohms. In this embodiment, no additional matching circuits are necessary. With the RF front end integrated circuit 84 in operation, a high frequency current loop 92 is formed. More particularly, the high frequency current loop 92 is successively formed starting with an origin of the feed line 80, to the first main branch segment 46, to the bend segment 50, and to the second main branch segment 48. A terminus of the high frequency current loop 92 is the ground line 82. It is contemplated that the high frequency current loop 92 confines the current and electromagnetic fields on the radiating element 44. Thus, coupling between the PCB-printed antenna assembly 12 and nearby circuit components is reduced, that is, isolation from extraneous components is increased for achieving high radiation efficiency and not subject to de-tuning with the approaching objects. Because of the specific structural configuration of the radiating element 44, namely, the dividing of the first main branch segment 46 and the second main branch segment 48 such that the latter is bent back, reduces its overall dimensions or footprint for a given length of the radiating element 44. Based upon the configuration of the radiating element 44 described herein, the electrically conductive portions of the PCB-printed antenna assembly 12 may have a 20.3 mm length and a 9 mm width.

The ground line 82 is disposed toward the second end 54 of the first main branch segment 46, and is the terminus of the high frequency current loop 92. In this regard, the ground line 82 is understood to have a left edge 94 that is co-extensive with the left edge 76 of the first main branch segment 46. The feed line 80, on the other hand, is disposed centrally along the first main branch segment 46 between the ground line 82 (and specifically, its right edge 96), and the right edge 68/first end 52. A dimension K defines the length between a left edge 98 of the feed line 80 and the right edge 96 of the ground line 82, while a dimension L defines the length between a right edge 100 of the feed line 80 and the right edge 68 of the first main branch segment 46. The dimensions K and L may be adjusted to change the impedance of the high frequency current loop 92, and improve the return loss characteristics of the PCB-printed antenna assembly 12. In one contemplated embodiment, the dimension K is 6 mm, while the dimension L is 7.4 mm.

Most performance objectives may be achieved with a particular configuration of the radiating element 44, the feed line 80, and the ground line 82. Additional adjustments are possible with the aforementioned tuning block 78, which extends from the left edge 76 of the first main branch segment 46. In further detail, the tuning block 78 has a top edge 102 that is co-extensive with the upper lengthwise edge 62 of the first main branch segment 46. The top edge 102 has a length dimension M of 3 mm. The tuning block 78 also has a left edge 104 with a dimension N that defines the width thereof, which may be 1.5 mm. By adjusting the M and N dimensions, bandwidth and return loss characteristics may be further tuned.

As indicated above, the feed line 80 includes the feed port 88, which is connectible to the RF front end integrated circuit 84. In further detail, the feed port 88 is characterized by a bent segment 108 that has a width extending beyond that of feed line 80, that is, dimension I. The bent segment 108 is understood to improve the return loss characteristics, and increases the area upon which a shunt capacitor or other matching circuits are necessary between the antenna and the RF front end integrated circuit 84. There also are grounding pads 87 for interconnecting such matching circuit components. Additionally, it is understood that the bent segment 108 is connected to the microstrip line 89 through a bypass capacitor 91. It was noted above that the bottom surface 28 of the PCB substrate 24, and in particular the first section 34 thereof, includes an extended section 40 of electrically conductive laminate that is part of the ground plane 38. The extended section 40 is understood to have a coextensive footprint on the PCB substrate 24 as the bent segment 108.

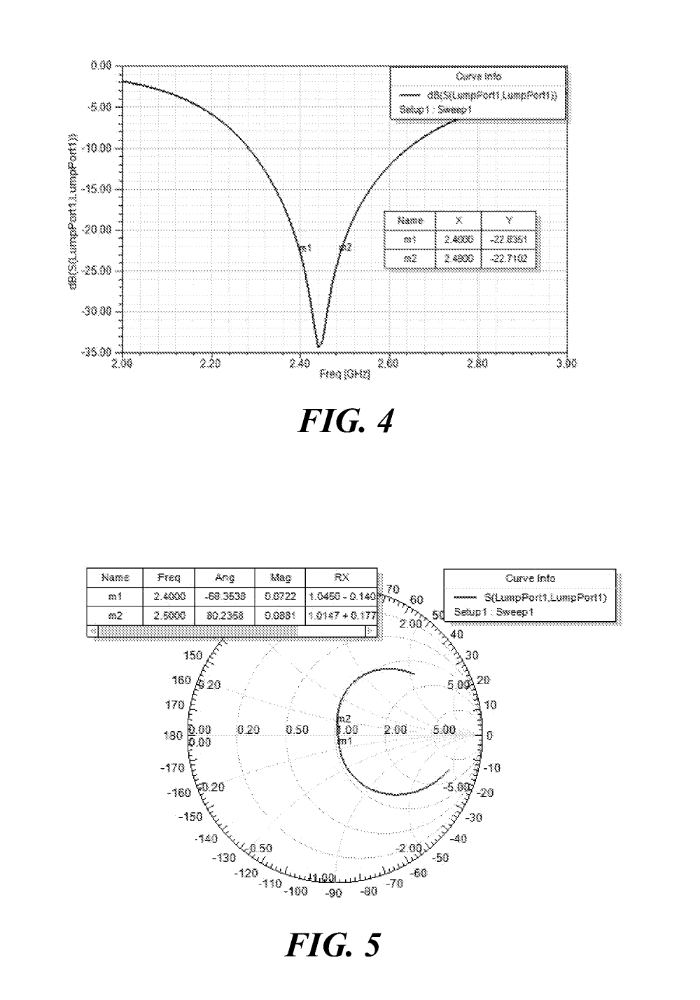

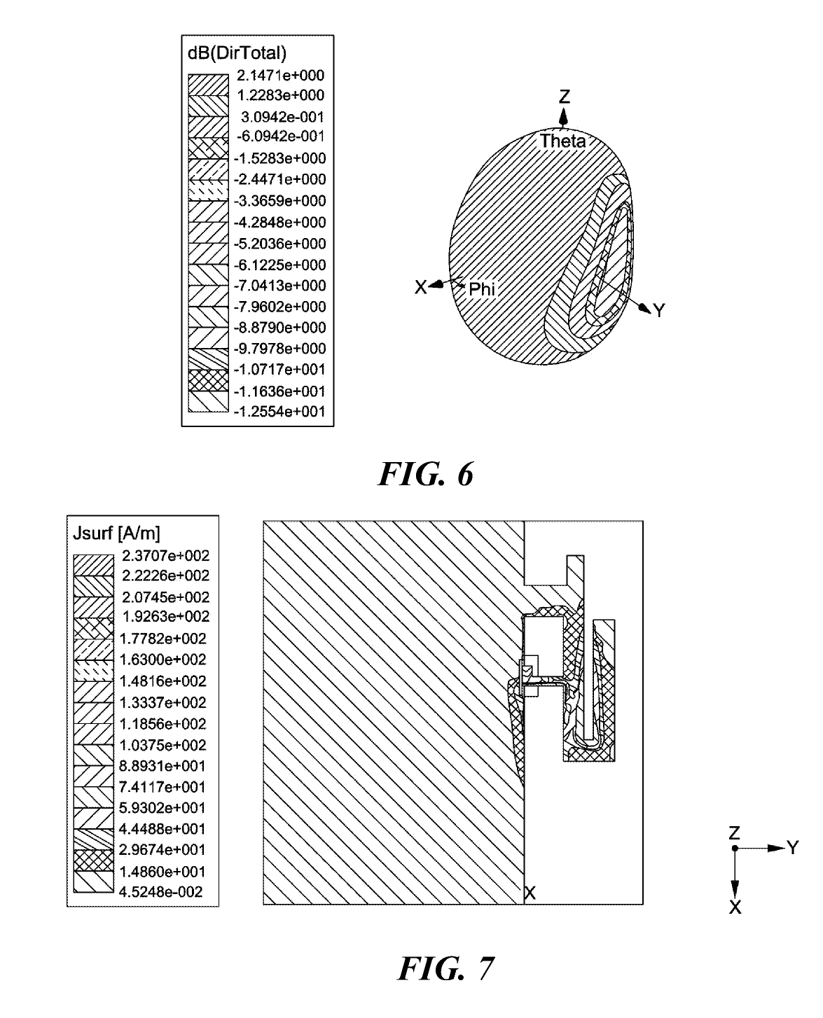

The PCB-printed antenna assembly 12 described herein is tuned for the 2.4-2.4835 GHz ISM band, and the simulation results thereof will be presented. The simulations have accounted for the components of the RF communications device 10 as discussed earlier. Again, it will be recognized that the various configuration parameters can be adjusted for different operating frequencies, and the exemplary details shown above are for such specific conditions. FIG. 4 is a chart illustrating the return loss as decibels in the specified operating frequency range, while FIG. 5 is a corresponding Smith chart showing the same. FIG. 6 is a three-dimensional representation of the radiation pattern of the PCB-printed antenna assembly 12, and as shown therein, there is an omni-directional radiation along the X-Z plane. In the Y direction, which corresponds to the relative positioning of the RF front end integrated circuit 84, the radiation field is weaker and hence less coupling. The simulation results show a peak gain of 2.15 dBi and a radiation efficiency of 94.7% at 2.45 GHz. Furthermore, FIG. 7 depicts the simulated current distribution pattern on the surface of the conductive elements of the PCB-printed antenna assembly 12. The current and electric fields are shown as confined in the radiating element 44 attributable to the high frequency current loop 92, leading to less coupling with surrounding circuit elements and higher radiation efficiency.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary for the fundamental understanding of the antenna assembly, the description taken with the drawings making apparent to those skilled in the art how the several forms of the present invention may be embodied in practice.

What is claimed is:

1. A printed circuit board (PCB)-printed antenna for a radio frequency (RF) front end integrated circuit with an antenna port, comprising:
a printed circuit board substrate;
an electrically conductive radiating element fixed to the printed circuit board substrate, the radiating element being defined by a first main branch segment, a second main branch segment in a spaced parallel relation thereto, and a perpendicular bend segment connecting the first and second main branch segments;
a feed line electrically connected to the radiating element, the feed line defining a feed port connectible to the antenna port of the RF front end integrated circuit; and
a ground line electrically connected to the radiating element, the ground line defining a ground port;
wherein a high frequency current loop is successively formed with an origin from the feed line, to the first main branch segment, to the bend segment, to the second main branch segment, and with a terminus of the ground line, the high frequency current loop confining current and electromagnetic fields on the radiating element.

2. The PCB-printed antenna of claim 1, wherein the first main branch segment of the radiating element has a first end proximal to the perpendicular bend segment and an opposed second end.

3. The PCB-printed antenna of claim 2, wherein the ground line is connected proximal to the second end of the first main branch segment and toward the terminus of the high frequency current loop.

4. The PCB-printed antenna of claim 2, wherein the feed line is connected central to the first end and the second end of the first main branch segment.

5. The PCB-printed antenna of claim 2, further comprising:
a tuning block connected to the second end of the radiating element.

6. The PCB-printed antenna of claim 1, wherein the printed circuit board substrate is defined by a top surface and an opposed bottom surface, the radiating element being fixed to the top surface.

7. The PCB-printed antenna of claim 6, further comprising:
a ground plane fixed to the bottom surface of the printed circuit board substrate.

8. The PCB-printed antenna of claim 7, wherein the feed line includes a bent segment coextensive with the feed port and being in substantial planar alignment with a partially extended portion of the ground plane.

9. The PCB-printed antenna of claim 1, wherein:
the feed line is integrally formed and mechanically contiguous with the radiating element; and
the ground line is integrally formed and mechanically contiguous with the radiating element.

10. The PCB-printed antenna of claim 1, wherein dimensions of the ground line are different from dimensions of the feed line.

11. The PCB-printed antenna of claim 10, wherein a width of the ground line is approximately three times a width of the feed line.

12. The PCB-printed antenna of claim 1, wherein a width of the radiating element is different from a width of the feed line.

13. The PCB-printed antenna of claim 12, wherein the width of the radiating element is two times the width of the feed line.

14. The PCB-printed antenna of claim 1, wherein the RF front end integrated circuit is mounted on the substrate.

15. The PCB-printed antenna of claim 14, wherein the RF front end integrated circuit is electrically connected to the feeding line over a microstrip line.

16. The PCB-printed antenna of claim 15, wherein the microstrip line has an impedance of 50 Ohms, matched to the impedance of the RF front end integrated circuit at the antenna port.

17. The PCB-printed antenna of claim 1, wherein the printed circuit board substrate conforms to the National Electrical Manufacturers Association (NEMA) FR-4 glass reinforced epoxy laminate specification having a 60 mil thickness.
